(19) United States
(12) Patent Application Publication
(10) Pub. No.: US 2005/0155237 A1
(43) Pub. Date: Jul. 21, 2005

(54) Refined laser leveler

(76) Inventor: Shih-Lin Lee, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/758,093

(22) Filed: Jan. 16, 2004

(51) Int. Cl. G01C 15/00

(52) U.S. Cl. 33/286

(57) ABSTRACT

A refined laser leveler is disclosed. The leveler includes a case having a fixed base contained therein, and a laser transmitter and conducting pieces both mounted at a front end thereof, wherein a power supplier is connected to a back end of the conducting pieces and a controlling element is mounted at a position corresponding to the conducting pieces. The controlling element has a hole mounted thereon and a light splitter mounted below the hole and the controlling element is slid in sliding troughs located at two sides of the case. When the user moves the controlling element to slide downward, the controlling element will therefore be electrically conducted through being contacted with the conducting pieces so as to enable the laser transmitter to produce a beam, wherein the beam is radiated through the hole on the controlling element so that a projection of the beam will show a spot. When the user moves the controlling element upward, the beam will pass through the light splitter so that a projection of the beam will be a vertical shadow. If the controlling element is then further moved upward, the laser beam will be aimed at a center of the light splitter so that the projection of the beam will show a cross shadow. Therefore, through three types of beams, an operating efficiency and range of the refined laser leveler is significantly increased.

### BACKGROUND OF THE INVENTION

1. Field of the Invention

The present invention is related to a refined laser leveler, and more particularly to a refined laser leveler which can provide three different types of laser beams for significantly increasing the operating efficiency and range.

2. Description of the Prior Art

Because modern people pay more and more attention to living quality, the requirements of housing decoration are significantly increased, especially the ceiling and any other structures, which needs to take care of the horizontal and vertical problems. Currently, these problems are overcome through employing a leveler. The conventional leveler can produce a vertical beam, and the user can therefore proceed a vertical checking through the produced vertical beam. However, when the user needs to proceed a horizontal checking, it has to turn the leveler over 90 degrees for converting the vertical beam into a horizontal one. Although this conventional leveler can achieve the requirements described above, it is obvious that in addition to bothering the user, constantly turning over the leveler will further increase the construction time.

Thus, it can be seen, the prior art described above still has some defects, is not a good design, however, and is urgently to be improved.

Because of the technical defects of described above, the applicant keeps on carving unflaggingly to develop a refined laser leveler through wholehearted experience and research.

### SUMMARY OF THE INVENTION

An object of the present invention is to provide a refined laser leveler which can provide different types of checking beams for significantly increasing the operation efficiency.

Another object of the present invention is to provide a refined laser leveler having a simple structure and can be operated easily.

Another further object of the present invention is to provide a refined laser leveler whose application range and field can be significantly increased.

Additional object of the present invention is to provide a refined laser leveler which has an easy manufacturing process.

For achieving the purposes described above, the refined laser leveler according to the present invention includes a case having a fixed base contained therein, wherein the fixed base includes two perpendicular level bubble calibrators are mounted at a top end thereof, a laser transmitter and conducting pieces are mounted at a front end thereof and a power supplier connected to a back end of the conducting pieces, a light bulb mounted at a front end of bottom surface thereof and supplied by the power supplier, and a switch mounted at a side surface thereof for controlling the light bulb; and a controlling element mounted at a position corresponding to the front end of the conducting piece and having a groove respectively mounted at two sides thereof so that the movement of the controlling element can have sections through the groove and wedging blocks in a sliding trough located at an inner side wall of the case, a hole mounted thereon, a light splitter mounted below the hole, two protruded blocks mounted at a back end thereof, and a trigger block mounted at a from end thereof so that the protruded blocks can trigger the conducting pieces for conduction through the trigger block, wherein an upper half of the light splitter is a vertical grating and a lower half of the light splitter is a horizontal grating. The case further includes openings which are respectively located at a position corresponding the level bubble calibrator, the controlling element, the switch and the light bulb for facilitating operation, and a magnetic object mounted at a bottom surface thereof for being attracted on a platform. When the user moves the controlling element upward, the protruded block of the controlling element will therefore be electrically conducted through being contacted with the conducting pieces so as to enable the laser transmitter to produce a beam, wherein the beam is radiated through the hole on the controlling element so that a projection of the beam will show a spot. When the user moves the controlling element upward, the beam will pass through the light splitter so that a projection of the beam will be a vertical shadow. If the controlling element is then further moved upward, the laser beam will be aimed at a center of the light splitter so that the projection of the beam will show a cross shadow. Therefore, through three types of beams, an operating efficiency and range of the refined laser leveler is significantly increased.

### BRIEF DESCRIPTION OF THE DRAWINGS

The drawings disclose an illustrative embodiment of the present invention which serves to exemplify the various advantages and objects hereof, and are as follows:

FIG. 1 is a three-dimensional decomposition drawing showing a refined laser leveler according to the present invention;

FIG. 2 is a three-dimensional assembling view showing a refined laser leveler according to the present invention;

FIG. 3 is a schematic view showing a practicing of a spot beam of a refined laser leveler according to the present invention;

FIG. 4 is a schematic view showing a practicing of a vertical beam of a refined laser leveler according to the present invention;

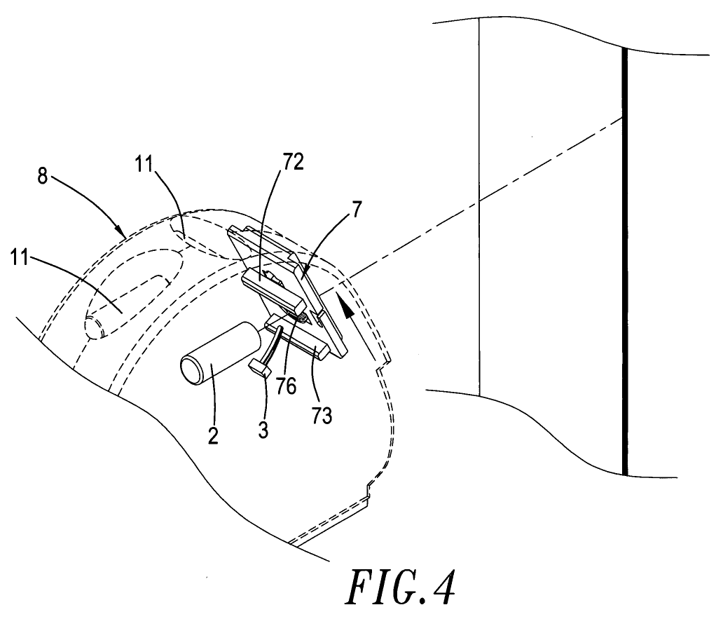

FIG. 5 is a schematic view showing a practicing of a cross beam of a refined laser leveler according to the present invention; and

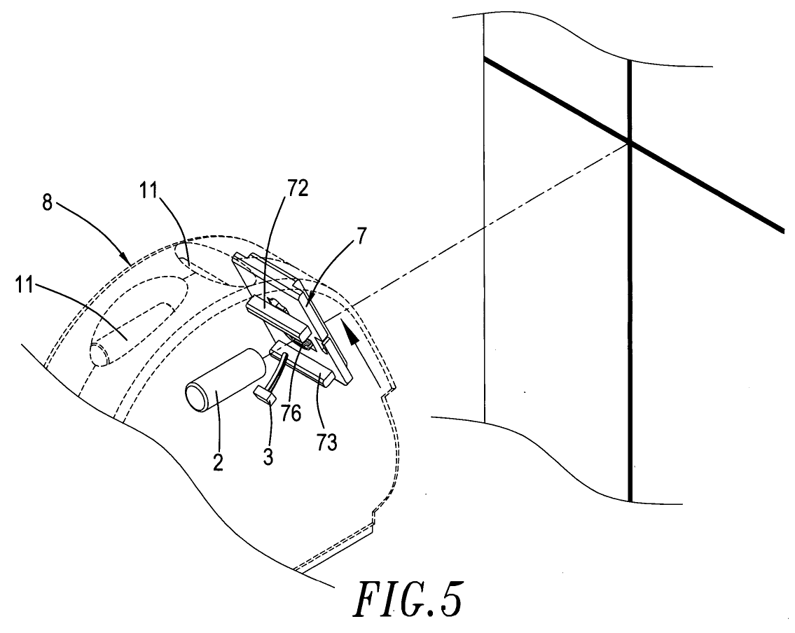

FIG. 6 is a schematic view showing a refined laser leveler in another preferred embodiment according to the present invention.

### DETAILED DESCRIPTION OF THE PREFERRED EMBODIMENT

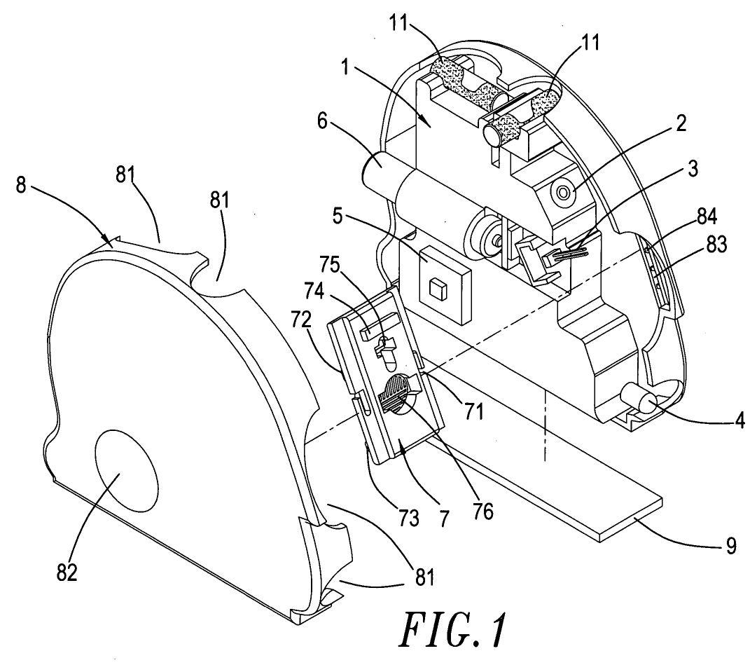

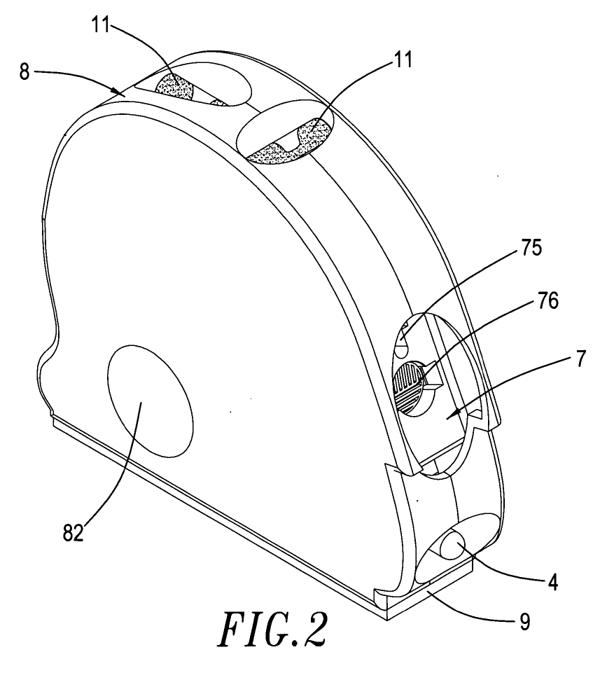

Please refer to FIGS. 1 and 2 which respectively illustrate three-dimensional decomposition drawing and assembling schematic view of a refined laser leveler according to the present invention. The refined laser leveler includes:
a fixed base 1, wherein two perpendicular bubble calibrators 11 are mounted at a top end thereof, a laser transmitter 2 is contained in a front end thereof, two conducting pieces 3 are mounted thereon, a light bulb 4 is set at a front edge of a bottom surface thereof, a switch 5 is mounted at a side surface thereof for controlling the light bulb 4, wherein a power supplier 6 is further connected to a back end of the conducting pieces 3 for providing power to the laser transmitter 2 and the light bulb 4;
a controlling element 7, wherein a groove 71 is mounted at two sides thereof, a first protruded block 72 and a second protruded block 73 are parallel to each other and mounted at a back end thereof, a trigger block 74 is mounted at a front end thereof, a hole 75 is set thereon, a light splitter 76 is mounted below the hole 75, and an upper half of the light splitter 76 is a vertical grating and an lower half of the light splitter is a horizontal grating, wherein the controlling element 7 is mounted at a front end of the conducting pieces 3 so that the first protruded block 72 or the second protruded block 73 can move the conducting pieces 3 as sliding;
a case 8, wherein the case 8 is employed to cover the fixed base 1 and the controlling element 7 and an opening 81 is respectively located at a position corresponding to the level bubble calibrator 11, the controlling element 7 the switch 5 and the light bulb 4 for exposing thereof for operation, a button 82 is mounted on the opening of the switch 5 for being pressed, a sliding trough 83 is further mounted at a front end of an inner side wall of the case 8, plural wedging blocks 84 are mounted in the sliding trough 83, and thereby through matching the groove 71 of the controlling element 7 and the wedging block 84, the controlling element 7 can be slid in the sliding trough 83 so as to control a three-section sliding; and
a magnetic object 9, wherein the magnetic object 9 is connectedly mounted on a bottom surface of the case 8 so that the case 8 can be stably attracted on the platform.

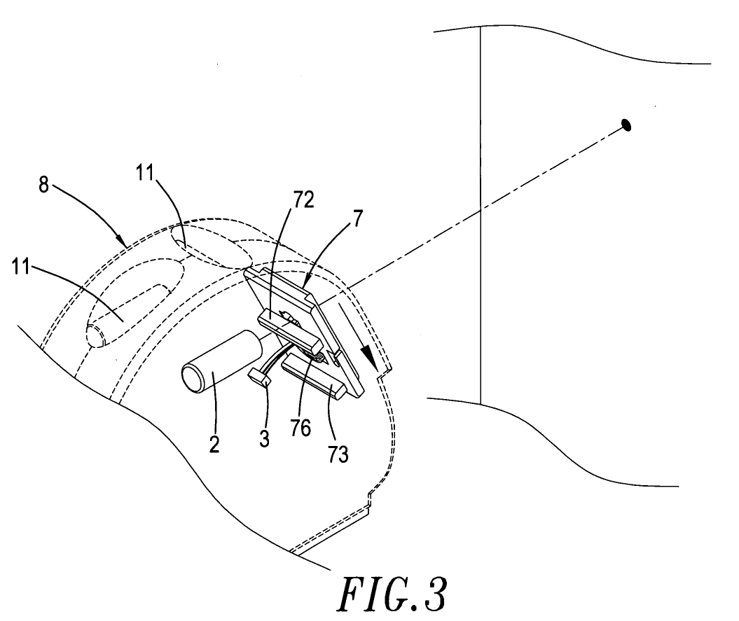

Please refer to FIGS. 3˜5 which illustrate schematic views showing three-section practicing of the refined laser leveler according to the present invention. When the user moves the controlling element 7 to slide downward through the trigger block 74, the first protruded block 72 of the controlling element 7 will therefore be electrically conducted through being contacted with the conducting piece 3 so as to enable the laser transmitter 2 to produce a beam, wherein the beam is radiated through the hole 75 on the controlling element 7 so that a projection of the beam will show a spot. When the user moves the controlling element 7 upward, the second protruded block 73 of the controlling element 7 will be conducted through being contacted with the conducting piece 3 so as to enable the laser transmitter 2 to produce a beam, wherein the beam will pass through the vertical grating on the light splitter 76 so that a projection of the beam will be a vertical shadow. If the controlling element 7 is now further moved upward, the laser beam will be passed through a center of the light splitter 76 so that through the vertical and the horizontal gratings on the light splitter, the projection of the beam will show a cross shadow. Therefore, through three types of beams, an operating efficiency and range of the present invention can be significantly increased.

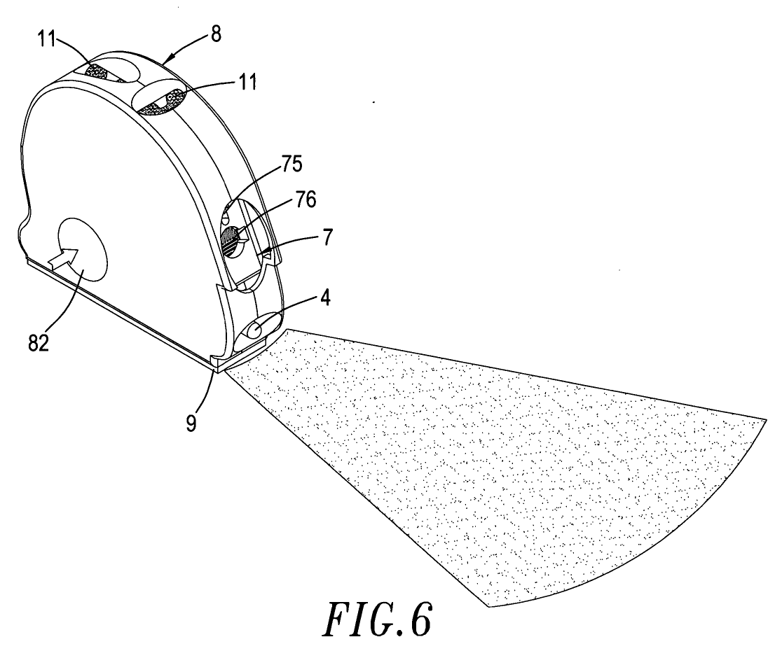

Please refer to FIG. 6 which illustrates a refined laser leveler in another preferred embodiment according to the present invention. In addition to providing three types of beams for checking, the present invention may further includes a light bulb 4 and a switch 5 for controlling thereof. Therefore, the refined laser leveler according to the present invention can also own the function of flashlight so as to provide illumination when being operated in the dark. Moreover, through the level bubble calibrator 11, the refined laser leveler according to the present invention may simultaneously provide a traditional horizontal measurement so that the present invention can provide different types of functions so as to broaden the application range and field.

The refined laser leveler according to the present invention, when being compared with the other prior arts, further includes the advantages as follows:

1. The present invention can be stably attracted on the platform for operation through a magnetic object mounted thereon.

2. The present invention can easily radiate three different types of beams through the controlling element so as to facilitate the operation and increase the fields to which can be applied.

3. The present invention can produce different types of laser beams through setting the light splitter so as to be a flexible laser leveler.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

1. A refined laser leveler, comprising:
a fixed base having a laser transmitter and two conducting pieces mounted at a front end thereof and a power supplier mounted thereon for supplying power;
a controlling element slidably mounted adjacent a front edge of said conducting pieces for concurrent selective control of said laser transmitter actuation and configuration of a laser beam generated thereby, said controlling element having at least one protruded block mounted at a back end thereof, a trigger block mounted at a front end thereof, a hole and a beam splitter mounted thereon, wherein said beam splitter comprises a vertical grating and a horizontal grating; said protruded block in a first position deflecting at least one of said conducting pieces to contact the other, and in a second position being spaced from said conducting pieces, whereby actuation of said laser transmitter is selectively enabled; and
a case for covering said fixed base and said controlling element and having an opening located at a position corresponding to said controlling element for sliding said controlling element in said opening;
thereby different types of checking beams including a spot beam, a vertical beam and a cross beam are respectively produced through a three-section control of a slide of said controlling element.

2. The refined laser leveler according to claim 1, wherein a plurality of said trigger blocks are formed on said controlling element.

3. The refined laser leveler according to claim 1, wherein said fixed base further comprises a light bulb mounted at said front end thereof and a switch mounted at a side end thereof for controlling said light bulb.

4. The refined laser leveler according to claim 1, wherein said case further comprises a magnetic object mounted at a bottom surface thereof for being attracted on a platform.

5. The refined laser leveler according to claim 4, wherein said magnetic object is a magnet.

6. The refined laser leveler according to claim 1, wherein said fixed base further comprises at least a level bubble calibrator mounted at a top end thereof.

7. The refined laser leveler according to claim 6, wherein said at least a level bubble calibrator is two perpendicular level bubble calibrators mounted.

8. The refined laser leveler according to claim 1, wherein said power supplier is a battery and mounted at a back end of said conducting piece for supplying power.

9. The refined laser leveler according to claim 1, wherein said vertical grating is mounted at one of an upper half and a lower half of said light splitters and said horizontal grating is mounted at the other of said upper and lower halves of said light splitter.

10. The refined laser leveler according to claim 1, wherein said controlling element further comprises a positioning groove formed at each of two sides thereof.

11. The refined laser leveler according to claim 1, wherein said case further comprises a sliding trough formed at each of two sides thereof and plural wedging blocks mounted in said sliding trough for positioning said controlling element.
